(19) United States
(12) Patent Application Publication
(10) Pub. No.: US 2012/0130832 A1
(43) Pub. Date: May 24, 2012

(54) HOST TO CLIENT PAYMENT

(75) Inventors: Samuel W. Bellamy, III, Bryn Mawr, PA (US); Christopher R. Kronenthal, Penn Valley, PA (US)

(73) Assignee: FreedomPay Inc., Radnor, PA (US)

(21) Appl. No.: 13/350,814

(22) Filed: Jan. 15, 2012

Related U.S. Application Data
(60) Provisional application No. 61/560,791, filed on Nov. 16, 2011.
(60) Provisional application No. 61/560,797, filed on Nov. 16, 2011.

(51) Int. Cl. G06Q 20/20; G06Q 20/40

(52) U.S. Cl. 705/18

(57) ABSTRACT

A system and a method of electronic transactions are disclosed. The system and method allow a consumer mobile device to capture the identification of a point-of-sale device and to initialize a transaction from the consumer mobile device to a master host platform. The point-of-sale device captures purchase items following a typical tender process and provides the master host platform with detailed purchase information. The master host platform instantiates a transaction merger to combine the identification information and the detailed purchase information. The transaction merger links the specific consumer to the specific transaction at the specific point-of-sale device. Then, the master host platform sends an authorization request to a payment processing host. The master host platform provides a connection between clients: the consumer mobile device and the point-of-sale device, and establishes a common interface between the clients and the payment processing host.

### CROSS REFERENCE TO RELATED APPLICATIONS

This application claims benefit from U.S. Provisional Patent Applications Nos. 61/560,791 and 61/560,797 filed on Nov. 16, 2011, which are hereby incorporated by reference.

### FIELD OF THE INVENTION

The present invention relates to systems and methods of electronic transactions, and more particularly to systems and methods of commercial and financial transactions using consumer mobile devices, point-of-sale devices, master host platforms, gateways, and payment processing hosts.

### BACKGROUND OF THE INVENTION

Traditionally, processes of payment and coupon redemption occur through point-of-sale systems of retailers with input from consumers and cashiers. The processes are expensive to retailers and risky to consumers due to the release of personal identifiers and payment mechanisms beyond their individual control. The present invention discloses an innovative transaction flow contrary to traditional transaction flows at points-of-sale. As opposed to traditional systems where points-of-sale accept consumer identifications for electronic payment and incentive redemption, the present invention allows consumer mobile devices to capture identifications of the points-of-sale and to initialize transactions from the consumer mobile devices to a master host platform. The points-of-sale capture purchase items and provide the master host platform with sale tickets which include detailed purchase information. The master host platform merges the identification information sent from the consumer mobile devices and the detailed purchase information sent from the points-of-sale. The merger links a specific consumer to a specific purchase transaction at a specific point-of-sale. This approach supports greater ubiquity in facilitating purchase transactions, reduces risks to consumers, reduces costs of acceptance for retailers, supports person-to-person transactions without delays and costs associated with hardware distribution, and improves the quality of deliverable through reduction in complexity and points of failure.

US Pat. Pub. No. 2011/0264543 A1 (Teveau et al, 2011) discloses a system and method of payment transactions, in which payment flows are reversed from conventional systems and methods. In this disclosure, a payment flow is from a merchant to a consumer mobile device and then to a financial service provider. In this disclosure, the consumer's ID is released to the merchant by the consumer or the financial service provider. In addition, in the system and method, there exist risks to expose the payment mechanisms beyond the consumer's control. U.S. Pat. No. 8,045,956 B1 (Sun et al., 2011) discloses a method which handles payment transactions in a system using consumer mobile devices. The consumer mobile devices act as smart cards and store data representing money amounts. When a consumer mobile device and a transaction terminal of a merchant are in proximity with each other, a link is established. Through communications using the link, the stored value of money in the mobile device will be deducted for a particular purchase transaction. The method has an operating server which is for receiving records, managing the stored data representing money amounts on the consumer mobile devices. US Pat. Pub. No. 2010/0133335 A1 (Maguid et al, 2010) discloses a system and a method for mobile payment. In the system and the method, a user's mobile telephony device has an affixed wireless identification tag. When the mobile telephony device and an identification tag reader of a point-of-sale are in proximity with each other, the point-of-sale receives the user's identification number. Then, the point-of-sale submits the user's identification number and the purchase amount to a transaction treatment platform. US Pat. Pub. No. 2008/0238610 A1 (Rosenberg, 2008) discloses a method of a near-field-communication enabled mobile communication which is used in transactions at a point-of-sale. In the method, user's information is released to the point-of-sale when a mobile device with a smartcard chip is placed near a near-field-communication reader of the point-of-sale. Upon receiving the user's information, the point-of-sale provides the information to point-of-sale's financial institute server and traditional transaction processing begins.

Earlier disclosures fail to disclose the innovative transaction flow disclosed in the present invention. And, earlier disclosures fail to disclose systems and methods which reduce risks due to release of consumer's IDs and due to exposure of payment mechanisms.

### SUMMARY OF THE INVENTION

The present invention discloses a system of electronic transactions: Host to Client Payment. The present system comprises a plurality of point-of-sale devices, a plurality of consumer mobile devices, at least one master host platform, at least one gateway, and a plurality of payment processing hosts. The master host platform comprises a plurality of controllers, a plurality of host applications, and a plurality of connectors. The controllers are for remote management control of the point-of-sale devices and the consumer mobile devices. The controllers manage communications between the host applications in the master host platform and the point-of-sale devices, and communications between the host applications in the master host platform and the consumer mobile devices. The host applications comprise unique application and enterprise application functionalities. All logic and work-flow reside within state-machines of the host applications. The connectors manage communications between the gateway and the host applications. The connectors are also interfaces between the host applications and non-payment hosts including loyalty, incentives, data warehousing, enterprise resource planning platform, and market database service. The gateway is a transaction gateway capable of passing any transaction data in multiple levels of hierarchy. The gateway functions in the conversion of data mapping from one format to another and conversion of messaging protocols. The master host platform invokes, manages, and controls custom operations of the gateway. The gateway is a common interface of transactions between clients (the point-of-sale devices and the consumer mobile devices) and the payment processing hosts. The payment processing hosts include third party processors, stored value processors, payment processors, card associations, issuing banks, and acquiring banks. The master host platform, in one embodiment, invokes, manages, and controls custom operations of a rules engine.

In the present system of electronic transactions, a consumer mobile device captures a terminal ID which is an identifier of a specific point-of-sale device. A client application of the consumer mobile device allows the capture of the terminal ID of the specific point-of-sale device through visual capture, electronic capture, audio capture, or manual entry by a consumer. The visual capture includes scanning of 1D, 2D, or 3D barcodes such as Microsoft Tag and Quick Response Codes. The electronic capture includes methods of radio frequency identification (RFID) and near field communication (NFC). The audio capture includes tones and commands means. Upon completion of the terminal ID capture, the client application of the consumer mobile device sends identification information, including the terminal ID as well as a ID of the mobile device, to the master host platform. Other identification information may include a consumer's personal identification number and a short-lived certificate for security purposes. By sending the identification information, the consumer mobile device notifies the master host platform that a consumer's account identified in the identification information is conducting a transaction at the specific point-of-sale device identified by the terminal ID. The master host platform queues the request of the transaction and reserves an event for receiving a sale ticket including detailed purchase information from the specific point-of-sale device.

The specific point-of-sale device captures each purchase item. The capture of purchase items at the point-of-sale, either through a cashier or a self-checkout, follows a typical tender process. Upon completion of the capture, the specific point-of-sale device builds the sale ticket including all detailed purchase information. And, the specific point-of-sale device sends the sale ticket and a payment request to the master host platform in a certified format and protocol.

Upon receiving the identification information and the sale ticket including the detailed purchase information, one of the host applications in the master host platform instantiates a transaction merger to combine the identification information sent from the consumer mobile device and the detailed purchase information sent from the specific point-of-sale device, following proper rules surrounding format, content, and timeout. Requested by the consumer at the time of the purchase, the master host platform may create a request for split tender payment available with application of other forms of payment or discounts through incentives. The master host platform sends the consumer mobile device a payment confirmation request for consumer's confirmation of the payment method and the payment amount. The consumer mobile device sends the confirmation to the master host platform. Alter receiving the consumer's confirmation, the master host platform immediately conducts the process of payment authorization with or without further communication with the point-of-sale device. The payer identification for payment applies fully in the confine of the consumer control; hence, there exists no risk to expose the payment mechanism beyond consumer's control. Also, incentives apply with no human intervention or action.

Upon completion of the transaction merger and the consumer's confirmation, the master host platform builds an authorization request for the payment value at the minimum value of balance due or the split tender payment. When electronic payment is requested, the master host platform sends the authorization request to at least one of the payment processing hosts through the gateway. The authorization request is in formats of communication protocols as required by the payment processing hosts.

The master host platform receives an authorization response from the at least one of payment processing hosts through the gateway, and builds a point-of-sale response and a consumer response. The point-of-sale response is sent to the point-of-sale device, and the consumer response is sent to the consumer mobile device. The master host platform communicates with the point-of-sale device on the approval or declination status of the payment request made by the point-of-sale device and the application of incentives. On approval, the point-of-sale device completes a tender close. In sending the consumer response, the master host platform notifies the consumer mobile device of the payment authorization and provides the consumer mobile device with a pro-form a ticket receipt. The pro-form a receipt includes the approval of payment with payment network authorization and incentive redemption. The methods of the communication between the master host platform and the consumer mobile device include mobile application, short message service (SMS), multimedia messaging service, e-mail, and daemon service on the consumer mobile device.

The present invention discloses a method of electronic transactions: Host to Client Payment. In processing an electronic transaction, the method comprises:

(1) A consumer mobile device captures a terminal ID of a point-of-sale device. The capture of the terminal ID may occur at any point before, during, or immediately after a purchase tender. The consumer mobile device acquires the terminal ID through visual capture (i.e. scanning of an 1D, 2D, or 3D barcord), electronic capture, audio capture, or manual entry.

(2) The consumer mobile device sends identification information to a master host platform. The identification information includes the terminal ID as well as a consumer mobile ID, and may further include a consumer's personal identification number and a short-lived certificate.

(3) The master host platform queues the electronic transaction and reserves an event for receiving a sale ticket from the point-of-sale device.

(4) The point-of-sale device captures purchase items by following a typical tender process, either through a cashier or a self-checkout.

(5) The point-of-sale device sends the sale ticket and an electronic payment request to the master host platform. The sale ticket includes detailed purchase information.

(6) The master host platform instantiates a transaction merger with proper rules surrounding format, content, and timeout, in which the master platform combines the identification information from the consumer mobile device and the detailed purchase information from the point-of-sale device.

(7) The master host platform sends a payment confirmation request to the consumer mobile device for consumer's confirmation of the payment method and amount.

(8) The consumer mobile device sends the consumer's confirmation to the master host platform.

(9) Upon the electronic payment request, the master host platform, through a gateway, sends an authorization request to at least one payment processing host.

(10) The master host platform, through the gateway, receives an authorization response from the at least one payment processing host.

(11) The master host platform sends a point-of-sale response to the point-of-sale device to notify status of approval or declination of the electronic payment request.

(12) The master host platform sends a consumer response to the consumer mobile device. The consumer response comprises a pro-form a receipt.

(13) The point-of-sale device completes a tender close upon being notified of the approval of the electronic payment request.

The advantages of the present invention are as follows:

(1) The present system and method provide secure electronic transactions over consumer mobile devices without need of additional hardware.

(2) The present system and method provide electronic communication connections between consumer mobile devices and point-of-sale devices of retailers through a secure third party connection.

(3) The present system and method provide real-time automated presentation of information, capture acceptance, and activation/application of actions upon electronic transactions.

(4) The present system and method provide secure transacting by using three-factor authentication: consumer mobile device ID, personal identification number (PIN), and short-lived certificate.

(5) The present system and method have an ability to centrally manage life spans of short-lived certificates, by various parameters, including but not limited to: time, number of transactions and monetary value.

(6) The present system and method have an ability to lower risks to consumers because payment mechanisms are fully in the control of consumers.

### BRIEF DESCRIPTION OF THE DRAWINGS

FIG. 1 is a diagram showing an exemplary system of electronic transactions: Host to Client Payment.

FIG. 2 is a diagram showing architecture of an exemplary system comprising a plurality of point-of-sale devices, a plurality of consumer mobile devices, a master host platform, a gateway, and a plurality of payment processing hosts.

FIG. 3 is a flow chart showing an exemplary method of electronic transactions using an exemplary system of electronic transactions shown in FIG. 1.

### DETAILED DESCRIPTION OF EXEMPLARY EMBODIMENTS

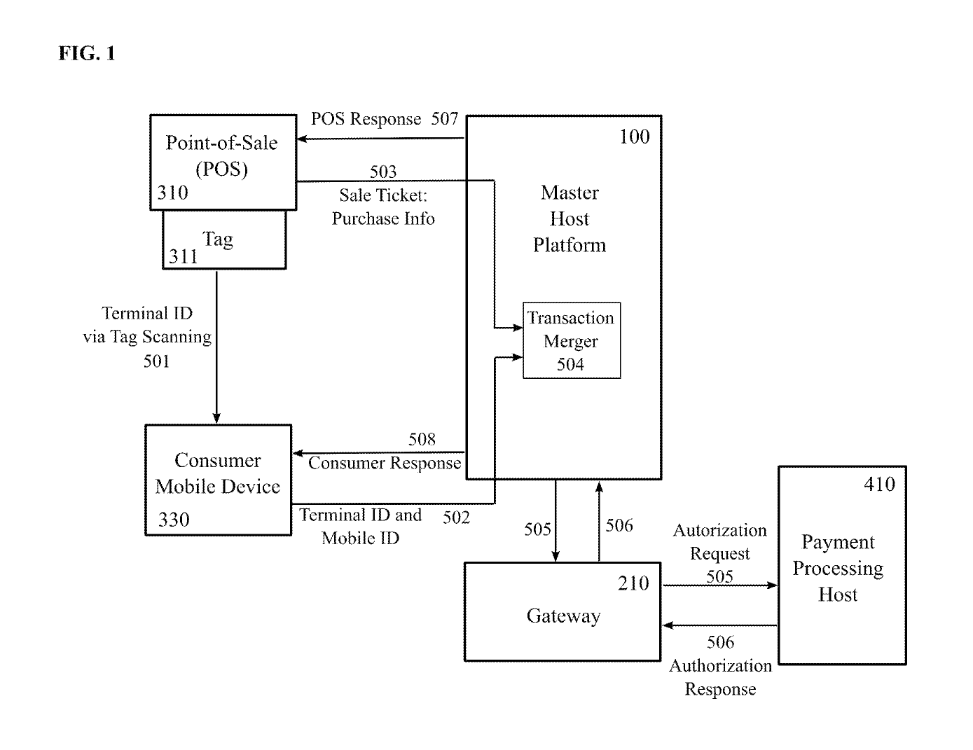

FIG. 1 presents a diagram of an exemplary embodiment of the present system of electronic transactions: Host to Client Payment. In the exemplary embodiment, the present system of electronic system comprises a master host platform 100, a gateway 210, a plurality of point-of-sale devices 310, a plurality of consumer mobile devices 330, and a plurality of payment processing hosts 410. The exemplary system further comprises 1D, 2D, or 3D barcode tags 311 attached on the point-of-sale devices 310. A specific one of the tags 311 contains a specific terminal ID which is in reference to a specific one of point-of-sale devices 310. The gateway 210 is a common interface of transactions between clients, which are the point-of-sale devices 310 and the consumer mobile devices 330, and the payment processing hosts 410. The gateway 210 is capable of passing any transaction data in multiple levels of hierarchy. The functions of the gateway 210 is the conversion of data mapping from one format to another and the conversion of messaging protocols. The payment processing hosts 410 are third party processors, stored value processors, payment processors, card associations, issuing banks, and acquiring banks.

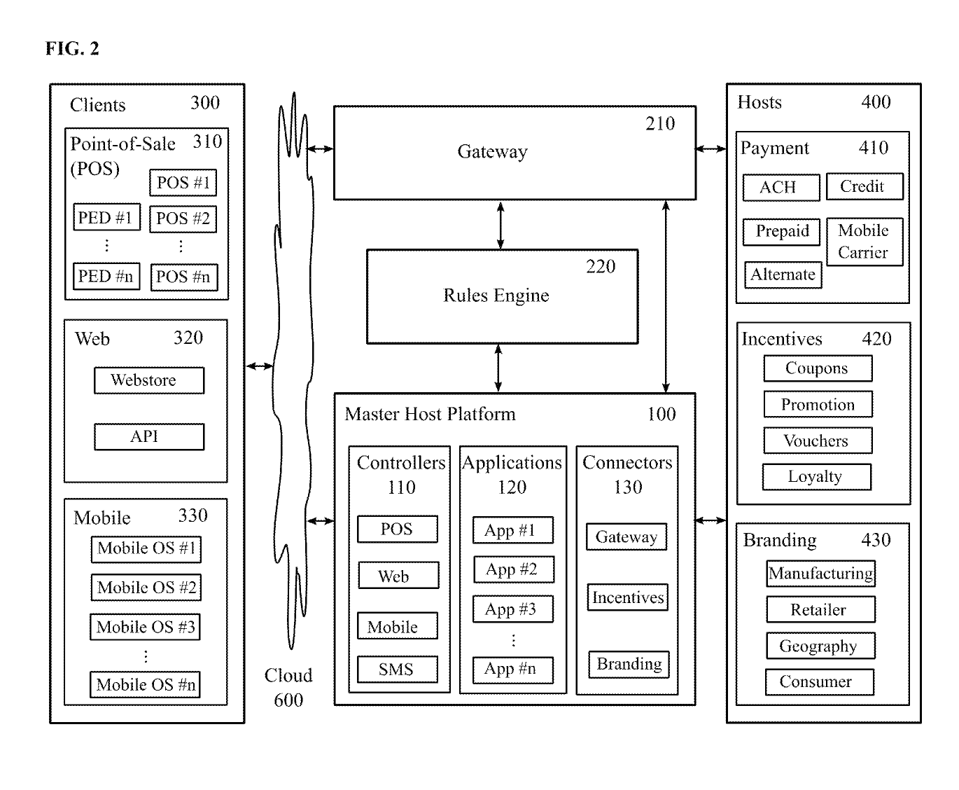

FIG. 2 presents a diagram illustrating the architecture of an exemplary system comprising a plurality of point-of-sale devices, a plurality of consumer mobile devices, a master host platform, a gateway, and a plurality of payment processing hosts. Referring to FIG. 2, the master host platform 100 comprises a plurality of controllers 110, a plurality of host applications 120, and a plurality of connectors 130. The plurality of controllers 110 are responsible for remote management control of the point-of-sale devices 310 and the consumer mobile devices 330. The plurality of controllers 110 manage the communications between the host applications 120 and the point-of-sale devices 310. Also, the plurality of controllers 110 manage the communications between the host applications 120 and the consumer mobile devices 330. The host applications 120 comprise unique application and enterprise application functionalities; all logic and work-flow reside within state-machines of the host applications 120. The connectors 130 manage communications between the host applications 120 and the gateway 210, and also communications between the host applications 120 and hosts of non-payment services such as incentives 420 and branding 430. In another embodiment, the master host platform 100 invokes, manages, and controls custom operations of a rules engine 220 which is tightly integrated with the gateway 210. The rules engine 220 is responsible for data validation upon input and exit on the basis of interrelationship at the field or column level and specific field/column level validation.

Referring to FIG. 1, one of the consumer mobile devices 330 captures the terminal ID of one of the point-of-sale devices 310 by scanning a tag 311. The tags 311 may be 1D, 2D, or 3D barcode tags, such as Microsoft Tag or Quick Response Codes. The capture of the terminal ID is represented by numeral 501. Alter completing the terminal ID capture, the one of the consumer mobile devices 330 sends identification information to the master host platform 100. The identification information includes the captured terminal ID and the consumer mobile device's ID. The other identification information sent from the one of the consumer mobile devices 330 to the master host platform 100 includes a consumer's personal identification number (PIN) and a short-lived certificate. The transmission of the identification information is represented by an arrow from the consumer mobile devices 330 to the master host platform 100 and denoted by numeral 502. A client application in the one of the consumer mobile devices 330 facilitates the capture and the transmission of the identification information. The one of the point-of-sale devices 310 captures purchase items following a typical tender process, either through a cashier or a self-checkout, and sends a sale ticket including detailed purchase information and a payment request to the master host platform 100. The detailed purchase information includes ticket header information, the terminal ID, line item details of each purchased item (including SKU, description, unit price, unit of measure, unit discount, extended price, serial number, and vehicle identification number), ticket subtotal, tax, ticket total, payment amount request, and other details. Transmission of the detailed purchase information and the payment request is represented by an arrow from the point-of-sale devices 310 to the master host platform 100 and denoted by numeral 503. The master host platform 100 receives the identification information from the one of the consumer mobile devices 330 and the detailed purchase information from the one of the point-of-sale devices 310, and instantiates a transaction merger by one of the host applications 120 (the host applications 120 are shown in FIG. 2) following proper rules surrounding format, content, and timeout. The transaction merger combines the identification information and the detailed purchase information. The transaction merger is represented in FIG. 1 by numeral 504. Upon the completion of the transaction merger and receiving confirmation from the one of the consumer mobile devices 330, the master host platform 100 builds an authorization request and sends it to at least one of the payment processing hosts 410 through the gateway 210. In another embodiment, the master host platform 100, requested by the one of the consumer mobile devices 330, creates an authorization request for split tender payment available with application of other forms of payment or discount through physical or virtual coupons, and sends the authorization request for split tender payment to the at least one of the payment processing hosts 410 through the gateway 210. The transmission of the authorization request is represented by an arrow from the master host platform 100 to the gateway 210 and an arrow from the gateway 210 to the payment processing hosts 410, and the transmission is denoted by numeral 505. After the transaction is processed at the at least one of the payment processing hosts 410, the master host platform 100 receives an authorization response from the at least one of the payment processing hosts 410 through the gateway 210. The transmission of the authorization response is represented by an arrow from the payment processing hosts 410 to the gateway 210 and an arrow from the gateway 210 to the master host platform 100, and the transmission is denoted by numeral 506. Upon receiving the authorization response from the at least one of the payment processing hosts 410, the master host platform 100 prepares a point-of-sale response and a consumer response. Sending the point-of-sale response to the one of the point-of-sale devices 310, the master host platform 100 notifies the approval or declination status of the payment request made by the one of the point-of-sale devices 310. The transmission of the point-of-sale response is represented by an arrow from the master host platform 100 to the point-of-sale devices 310 and denoted by numeral 507. Upon the approval, the one of the point-of-sale devices 310 completes a tender close. By sending the consumer response, the master host platform 100 notifies the one of the consumer mobile devices 330 of the payment authorization and provide the one of the consumer mobile devices 330 with a pro-form a receipt. The communication of sending the consumer response is represented by an arrow from the master host platform 100 to the consumer mobile devices 330 and denoted by numeral 508.

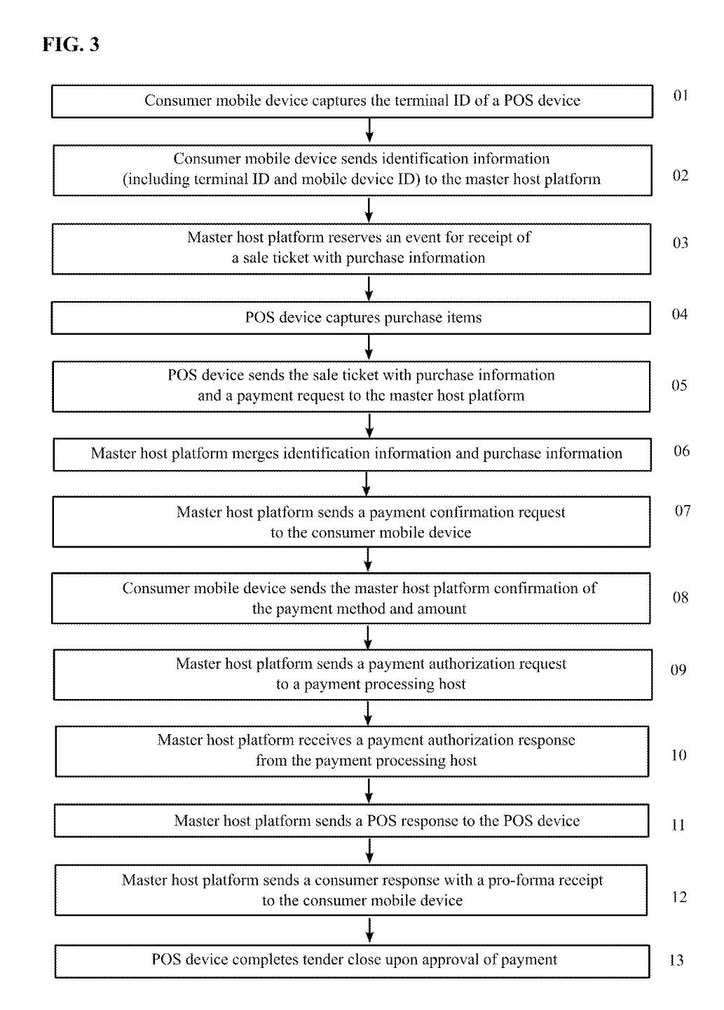

FIG. 3 shows a flow chart describing an exemplary method of electronic transactions using an exemplary system of electronic transactions shown in FIG. 1. The exemplary method comprises following steps. In other embodiments, the sequence of the steps described as follows will vary. At step 01, a consumer mobile device captures a terminal ID which is in reference to a specific point-of-sale device. A client application of the consumer mobile device facilitates the capture of the terminal ID. In other embodiments, the capture of the terminal ID may occur at any point in advance of, during, or immediately alter a purchase tender. At step 02, the consumer mobile device sends identification information, which includes the terminal ID and the ID of the consumer mobile device, to a master host platform. The identification information may further include a consumer's personal identification number (PIN) and a short-lived certificate. The client application of the consumer mobile device facilitates the transmission of the terminal ID. Through steps 01 and 02, a transaction is initialized at the master host platform by the consumer mobile device. At step 03, the master host platform queues the transaction and reserves an event for receipt of a sale ticket from the point-of-sale device. At step 04, the point-of-sale device captures purchase items following a typical tender process either through a cashier or a self-checkout, and builds the sale ticket including all detailed purchase information. At step 05, the point-of-sale device sends the sale ticket and a payment request to the master host platform. At step 06, the master host platform instantiates a transaction merger to combine the identification information sent from the consumer mobile device and the detailed purchase information sent from the point-of-sale device. The transaction merger follows certain rules surrounding the format, content, and timeout. At step 07, the master host platform sends a payment confirmation request, which requests confirmation of the payment method and the payment amount, to the consumer mobile device. At step 08, the consumer mobile device sends the confirmation of the payment method and the payment amount to the master host platform. At step 09, the master host platform builds an authorization request and sends it to at least one payment processing host through a gateway. The authorization request is in the format of the communication protocol required by the at least one payment processing host. At step 10, the master host platform receives an authorization response from the at least one payment processing host through the gateway. At step 11, the master host platform prepares a point-of-sale response and sends it to the point-of-sale device. In the point-of-sale response, the master host platform notifies the point-of-sale device of the approval or declination status of the payment request. At step 12, the master host platform prepares a consumer response and sends it to the consumer mobile device. In the consumer response, the master host platform notifies the consumer mobile device of the payment authorization and presents a pro-form a receipt to the consumer mobile device. Finally, at step 13, upon approval of the payment request made by the point-of-sale device at step 5, the point-of-sale device completes a tender close.

Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1. A method of electronic transactions comprising:
capturing, by a consumer mobile device, a terminal ID of a point-of-sale device;
receiving, by a master host platform and from said consumer mobile device, identification information including said terminal ID and an ID of said consumer mobile device;
reserving, by said master host platform, an event for receipt of a sale ticket with purchase information;
capturing purchase items by said point-of-sale device;
building, by said point-of-sale device, said sale ticket with said purchase information;
receiving, by said master host platform, said sale ticket and a payment request from said point-of-sale device;
merging, by said master host platform, said identification information sent from said consumer mobile device and said sale ticket with said purchase information sent from said point-of-sale device;
sending, by said master host platform, a payment confirmation request to said consumer mobile device;
receiving, by said master host platform, confirmation of a payment amount and a payment method from said consumer mobile device;
sending an authorization request from said master host platform to at least one payment processing host;
receiving, by said master host platform, an authorization response from said at least one payment processing host;
sending, from said master host platform, a point-of-sale response to said point-of-sale device;
sending, from said master host platform to said consumer mobile device, a consumer response; and
completing, by said point-of-sale device, a tender close upon approval of said payment request.

2. The method of electronic transactions of claim 1, wherein said consumer mobile device captures said terminal ID through scanning a 1D, 2D, or 3D barcode.

3. The method of electronic transactions of claim 1, wherein said consumer mobile device captures said terminal ID through an audio means.

4. The method of electronic transactions of claim 1, wherein said consumer mobile device captures said terminal ID through an electronic means.

5. The method of electronic transactions of claim 1, wherein said consumer mobile device captures said terminal ID through a manual entry.

6. The method of electronic transactions of claim 1, wherein said consumer mobile device captures said terminal ID at any point before, during, or immediately after a purchase tender.

7. The method of electronic transactions of claim 1, wherein said consumer response comprises a pro-form a receipt.

8. The method of electronic transactions of claim 1, wherein said identification information further comprises a personal identification number of a consumer and a short-lived certificate.

9. A system of electronic transactions comprising:
at least one master host platform, at least one gateway, a plurality of point-of-sale devices, a plurality of consumer mobile devices, and a plurality of payment processing hosts;
wherein a respective one of said plurality of consumer mobile devices captures a terminal ID of a respective one of said plurality of point-of-sale devices and sends identification information to said at least one master host platform, said identification information comprises said terminal ID and an ID of said respective one of said plurality of consumer mobile devices;
wherein said respective one of said plurality of point-of-sale devices captures purchase items, and sends a sale ticket with purchase information and a payment request to said at least one master host platform;
wherein said at least one master host platform merges said identification information and said purchase information;
wherein said at least one master host platform, through said at least one gateway, sends an authorization request to at least one of said plurality of payment processing hosts, and receives an authorization response from said at least one of said plurality of payment processing hosts;
wherein said at least one master host platform sends a point-of-sale response to said respective one of said plurality of point-of-sale devices; and
wherein said at least one master host platform sends a consumer response to said respective one of said plurality of consumer mobile devices.

10. The system of electronic transactions of claim 9, wherein said respective one of said plurality of consumer mobile devices has a client application, wherein said client application facilitates capture of said terminal ID, transmission of said identification information from said respective one of said plurality of consumer mobile devices to said at least one master host platform, and transmission of said consumer response from said at least one master host platform to said respective one of said plurality of consumer mobile devices.

11. The system of electronic transactions of claim 9, wherein said respective one of said plurality of point-of-sale devices has a client application, wherein said client application facilitates transmission of said purchase information from said respective one of said plurality of point-of-sale devices to said at least one master host platform and transmission of said point-of-sale response from said at least one master host platform to said respective one of said plurality of point-of-sale devices.

12. The system of electronic transactions of claim 9, wherein said identification information further comprises a personal identification number of a consumer and a short-lived certificate.

13. The system of electronic transactions of claim 9, wherein said consumer response comprises a pro-form a receipt.

14. The system of electronic transactions of claim 9, wherein said at least one gateway passes transaction data in multiple levels of hierarchy, converts data mapping formats, and converts messaging protocols, wherein said at least one master host platform invokes, manages, and controls custom operations of said at least one gateway.

15. The system of electronic transactions of claim 9, wherein said respective one of said plurality of consumer mobile devices captures said terminal ID of said respective one of said plurality of point-of-sale devices through scanning a 1D, 2D, or 3D barcode.

16. The system of electronic transactions of claim 9, wherein said respective one of said plurality of consumer mobile devices captures said terminal ID of said respective one of said plurality of point-of-sale devices through an audio means.

17. The system of electronic transactions of claim 9, wherein said respective one of said plurality of consumer mobile devices captures said terminal ID of said respective one of said plurality of point-of-sale devices through an electronic means.

18. The system of electronic transactions of claim 9, wherein said respective one of said plurality of consumer mobile devices captures said terminal ID of said respective one of said plurality of point-of-sale devices through a manual entry.
